(19) United States
(12) Patent Application Publication
(10) Pub. No.: US 2026/0000949 A1
(43) Pub. Date: Jan. 1, 2026

(54) MONOCOQUE PADDLES

(71) Applicant: Selkirk Sport, LLC, Coeur d'Alene, ID (US)

(72) Inventors: Michael Robert Eisele, Hayden, ID (US); Thomas Barnes, Hayden, ID (US)

(21) Appl. No.: 19/251,429

(22) Filed: Jun. 26, 2025

Related U.S. Application Data
(60) Provisional application No. 63/665,051, filed on Jun. 27, 2024.

(51) Int. Cl. A63B 59/42; A63B 102/08; B29C 51/10; B29C 51/18; B29C 51/30; B29L 31/52

(52) U.S. Cl. CPC A63B 59/42; B29C 51/10; B29C 51/18; B29C 51/30; A63B 2102/08; A63B 2209/00; B29L 2031/5245

(57) ABSTRACT

A method of forming a monocoque paddle may include forming a first half shell via an first mold, forming a second half shell via a second mold, placing a bladder between the first half shell and the second half shell between the first mold and the second mold, and applying energy to the first half shell and the second half shell via the bladder, the first mold, and the second mold.

### CROSS REFERENCE TO RELATED PATENT APPLICATIONS

This application is a non-provisional application that claims priority from U.S. Provisional Patent Application No. 63/665,051, filed Jun. 27, 2024, and incorporates the content thereof in its entirety by reference.

### TECHNICAL FIELD

The present disclosure relates generally to processes of manufacturing racket sports equipment. Specifically, the present disclosure relates to systems and methods for manufacturing monocoque paddles and a monocoque paddle manufactured via these systems and/or methods.

### BACKGROUND

Diverse types of sports are ubiquitously engaged in by participants for various reasons, including to improve health, for leisure and enjoyment, and competitive or professional purposes, among other reasons. One such sport that is quickly becoming a popular sport is pickleball. Pickleball is an indoor or outdoor paddle sport in which two (singles) or four (doubles) players hit a perforated, hollow plastic ball with paddles over a 34-inch-high net until one side is unable to return the ball or commits an infraction.

Equipment used in connection with pickleball play includes a paddle, which may be referred to as a pickleball paddle. Organizations such as the USA Pickleball (USAP) have established rules and guidelines as to what constitutes conforming pickleball paddles according to the specifications presented in, for example, the USA Pickleball Equipment Standards Manual (version 2.0, November 8023). These rules and guidelines indicate, among other things, design and manufacturing criteria for paddles that may be used in tournament play. For example, approved paddles may have characteristics or qualities that include a rigid, non-compressible material, a hitting surface that does not contain holes, indentations, rough texturing, or any objects or features that allow a player to impart excessive spin on the ball, a combined length and width, including any edge guard and butt cap, not exceeding 24 inches (in.) (e.g., 60.96 centimeters (cm)) and a length that does not exceed 17 in. (e.g., 43.18 cm), among other characteristics or qualities.

Manufacture of pickleball paddles or similar paddle equipment may be time consuming, expensive, and may not produce a paddle that meets an organization's standards or that may not produce the intended play quality.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an isometric view of a paddle, according to an example of the principles described herein.

FIG. 2 illustrates an isometric view of a paddle, according to an example of the principles described herein.

FIG. 3 illustrates a plan, front view of a paddle, according to an example of the principles described herein.

FIG. 4 illustrates a plan, side view of a paddle, according to an example of the principles described herein.

FIG. 5 illustrates a plan, top view of a paddle, according to an example of the principles described herein.

FIG. 6 illustrates a plan, bottom view of a paddle, according to an example of the principles described herein.

FIG. 7 illustrates an exploded, perspective view of elements utilized in the formation of a monocoque paddle, according to an example of the principles described herein.

FIG. 8 illustrates a perspective view of a first mold depicted in FIG. 7, according to an example of the principles described herein.

FIG. 9 illustrates a perspective view of a second mold depicted in FIG. 7, according to an example of the principles described herein.

FIG. 10 illustrates a perspective view of a bladder depicted in FIG. 7, according to an example of the principles described herein.

FIG. 11 illustrates a perspective view of a first half shell depicted in FIG. 7, according to an example of the principles described herein.

FIG. 12 illustrates a perspective view of a second half shell depicted in FIG. 7, according to an example of the principles described herein.

FIG. 13 illustrates a perspective, partially cutaway view of a paddle shell including the first half shell and the second half shell depicted in FIGS. 7, 11, and 12 as coupled together, according to an example of the principles described herein.

FIG. 14 illustrates a perspective, partially cutaway view of the paddle shell of FIG. 13, including a material injected into an internal void defined between the first half shell and the second half shell, according to an example of the principles described herein.

FIG. 15 illustrates a flow diagram of an example method of forming a paddle, according to an example of the principles described herein.

### DESCRIPTION OF EXAMPLE EMBODIMENTS

### Overview

This disclosure describes systems and methods for manufacturing a monocoque paddle and monocoque paddles manufactured via these systems and methods. A monocoque paddle produced by the methods and systems described herein may be relatively inexpensive to manufacture through a streamlined manufacturing process, which may provide for versatility in the design of the paddles. Further, the monocoque paddle produced by the methods and systems described herein may exhibit characteristics or qualities that are an improvement over other pickleball paddles including, for example, pickleball paddles that have a reduced weight as compared to other pickleball paddles, pickleball paddles that exhibit an increase in strength and/or durability, pickleball paddles that exhibit improved energy transfer when striking a pickleball, or other improved characteristics or qualities described herein. Therefore, the present monocoque pickleball paddle may provide advantages to a player, which may provide the player with an advantage over competitors.

As used in the present specification and the appended claims, the term “monocoque” may be meant to be understood broadly as any structural system in which loads are supported by the external “skin” or layer of the object. Monocoque (e.g., French for “single shell”) may also be referred to as a structural skin and may function like the shell of an egg. A monocoque structure of a pickleball paddle described herein may include a shell or a pair of mating shells that are not supported by an internal support, such as an internal framework of reinforcing architecture. In an embodiment, the innovative monocoque pickleball paddle may be constructed either entirely or partially from a thermoformable material such as, for example, thermoplastics. The use of thermoplastics in this instance may eliminate the need for internal cores used in the initial manufacturing process. Further, this single-piece construction significantly reduces weight, enhances durability, and improves energy transfer within the paddle, resulting in the ability to provide players with superior performance and handling during play. The manufacturing processes described herein further streamline manufacturing, which, in turn, reduces costs and increases product consistency among the end products of the paddles.

As used in the present specification and the appended claims, the term “energy” may be meant to be understood broadly as any quantitative property that is transferred to a physical system, such as, for example, heat, pressure, and combinations thereof. For example, the energy may be transferred to a stack of a pair of molds, half shells of a paddle, and/or a bladder placed between the half shells to form a paddle from the half shells via application of the energy to these elements.

Examples described herein provide a method of forming a monocoque paddle. The method may include forming a first half shell via a first mold, forming a second half shell via a second mold, arranging a bladder between the first half shell and the second half shell, positioning the first half shell, the bladder, and the second half shell between the first mold and the second mold, and applying energy to the first half shell and the second half shell via the bladder, the first mold, the second mold, or combinations thereof.

The method may further include welding the first half shell to the second half shell. Forming the first half shell via the first mold and forming the second half shell via the second mold may include thermoforming a thermoformable material via the first mold and the second mold. The method may further include forming an embossed feature on the thermoformable material via a negative feature formed on an interior portion of the first mold, the second mold, and combinations thereof.

The method may further include removing the bladder from between the first half shell and the second half shell, and filling a void formed between the first half shell and the second half shell with a filling material. The filling material may include a polyol or a polyurethane.

Applying energy to the first half shell and the second half shell via the bladder, the first mold, and the second mold may cause the first half shell and the second half shell to form a monocoque feature. The method may further include forming the first mold and forming the second mold. The application of the energy to the first half shell and the second half shell via the bladder, the first mold, the second mold, or combinations thereof may include application of heat, pressure, and combinations thereof.

Examples described herein also provide a monocoque paddle. The monocoque paddle may include a first half shell formed via a first mold, a second half shell formed via a second mold, and a joint formed between the first half shell and the second half shell via application of energy to the first half shell and the second half shell via a bladder, the first mold, and the second mold. The monocoque paddle may further include a material inserted between the first half shell and the second half shell in place of the bladder. The material may include a polyol or a polyurethane.

The first half shell and the second half shell may include a thermoformable material. The application of energy may include the application of heat, pressure, and combinations thereof.

Examples described herein also provide a monocoque paddle manufacturing system. The monocoque paddle manufacturing system may include a first mold for forming a first half shell, a second mold for forming a second half shell, a bladder for placement between the first half shell and the second half shell to create a void between the first half shell and the second half shell, and an energy application device to apply energy to the first half shell and the second half shell via the bladder, the first mold, the second mold, or combinations thereof.

The monocoque paddle manufacturing system may further include a welding device to weld the first half shell to the second half shell. The welding device comprises mechanical joining device, a cross-linking adhesive bonding device, a solvent-based adhesive bonding device, a hotmelt adhesive bonding device, an ultrasonic welding device, a vibration welding device, a heated tool welding device, a hot gas welding device, a hot wedge welding device, an extrusion welding device, a hot plate welding device, an implant induction welding device, an implant resistance welding device, a spin welding device, an electromagnetic welding device, a radio frequency (RF) welding device, an infrared welding device, a laser welding device, a microwave welding device, or combinations thereof.

The monocoque paddle manufacturing system may further include a first fluid injection device to create positive pressure within the bladder. The monocoque paddle manufacturing system may further include a second fluid injection device to fill a void formed between the first half shell and the second half shell with a filling material. The filling material may include a polyol or a polyurethane.

Additionally, the techniques described in this disclosure may be performed as a method and/or by a system having non-transitory computer-readable media storing computer-executable instructions that, when executed by one or more processors, performs the techniques described above.

### EXAMPLE EMBODIMENTS

This disclosure describes systems and methods for manufacturing a monocoque pickleball paddle, as well as monocoque paddles manufactured via these systems and methods. As described herein, it is advantageous to economically manufacture a paddle, such as a pickleball paddle, that has superior playability characteristics or qualities. The systems and methods described herein provide for such a paddle. In the realm of pickleball paddle design, approaches may employ a combination of thermoset materials, including a core encased by layers of composite materials such as graphite, fiberglass, and/or carbon fiber, along with a resin being applied to the carbon fiber. The core may serve as a primary structural component, but the core increases the overall weight and bulk of the paddle. The core also necessitates additional components, such as edge guards, to maintain structural integrity and mitigate impact damage.

The monocoque design for pickleball paddles described herein marks a significant departure from these traditional methods by eliminating the need for an internal core or support structure. Drawing on engineering principles used in aerospace and automotive industries, this design features a monocoque structure, where the external skin, which may be made from, for example, a thermoplastic, supports the structural loads within the paddle. The design implements a hollow skin that can be filled after molding in order to increase certain performance characteristics relating to, for example, noise reduction, vibration reduction, defining a sweet spot, etc.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

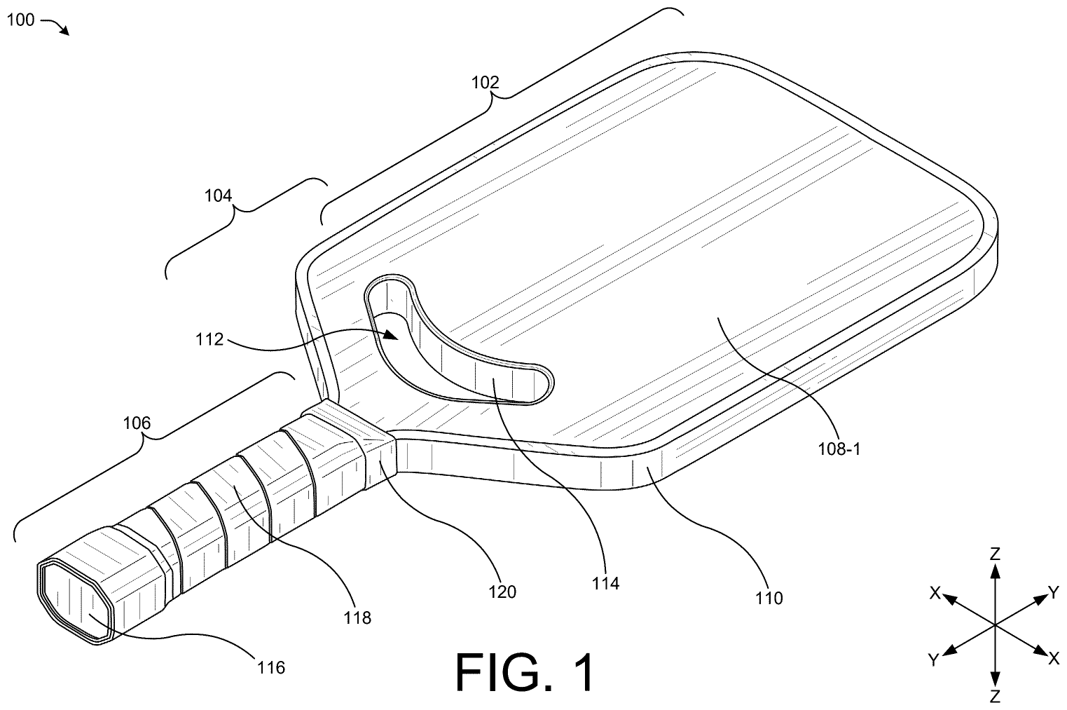

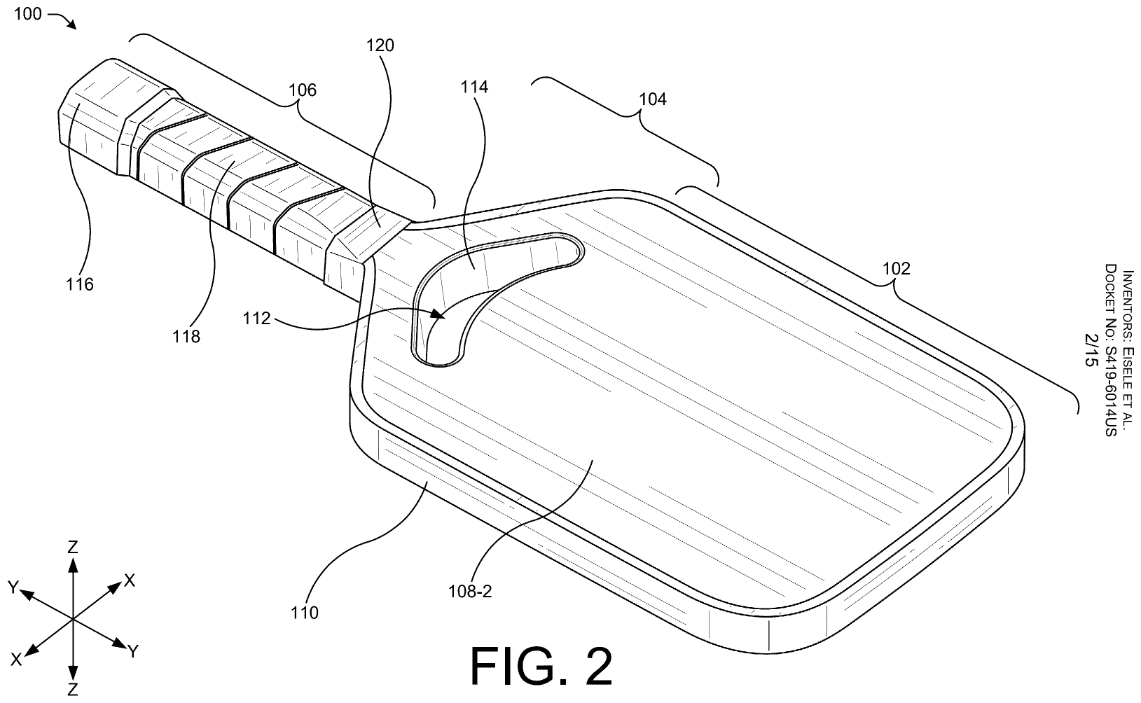

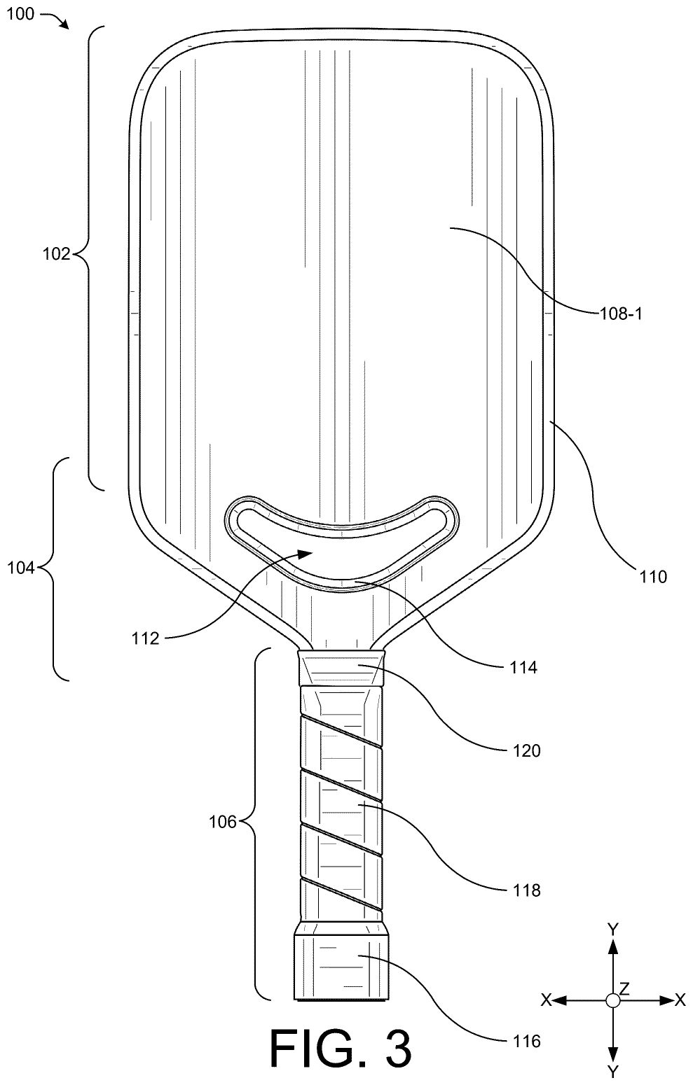

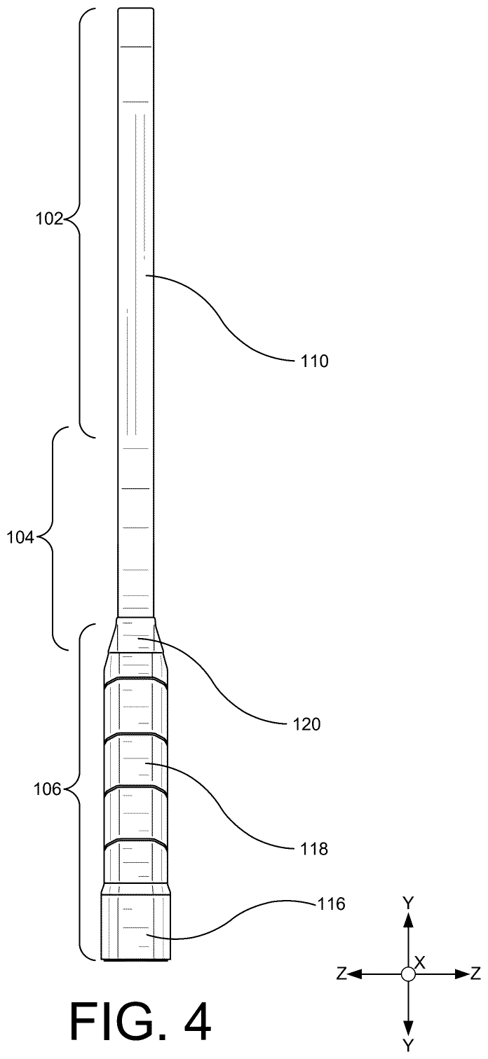

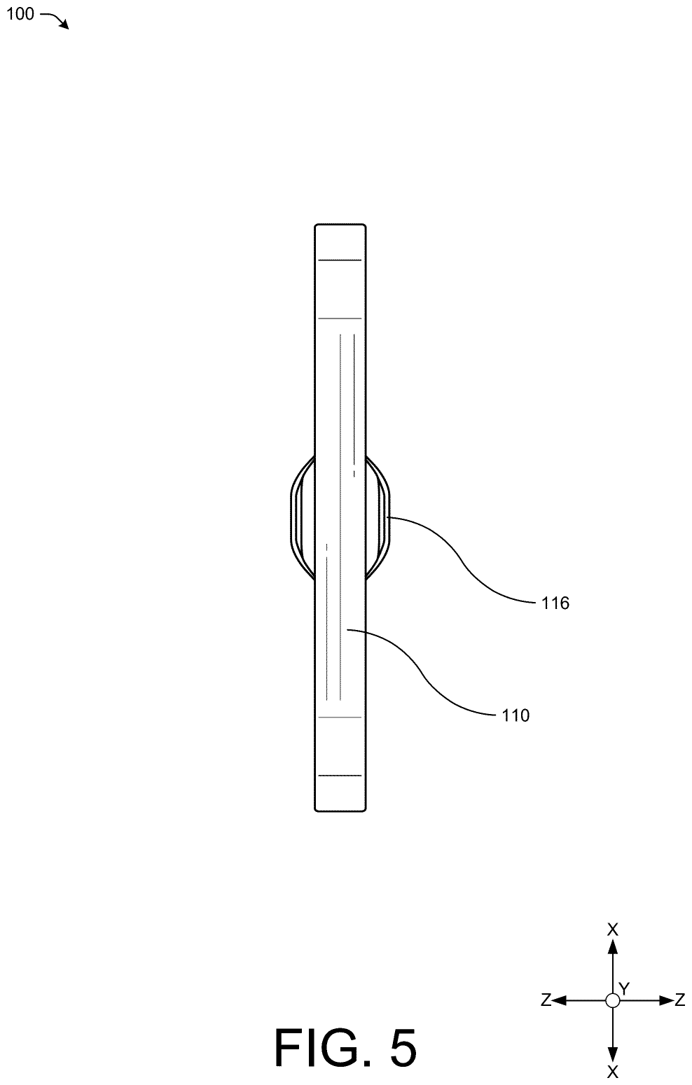

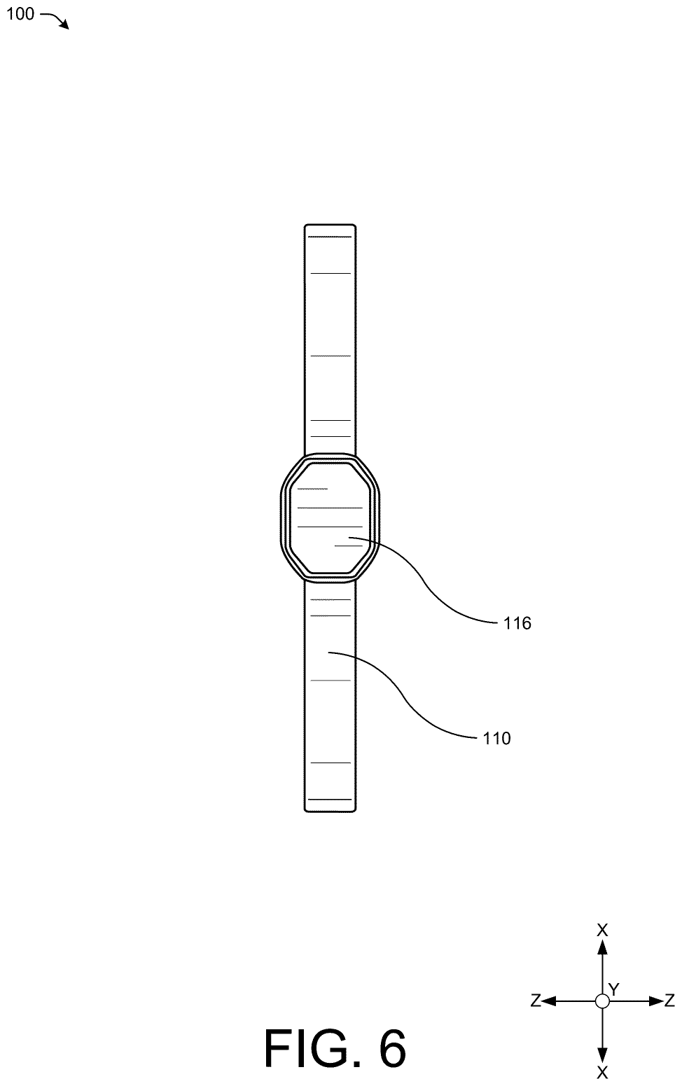

FIG. 1 illustrates an isometric view of a paddle 100, according to an example of the principles described herein. FIG. 2 illustrates an isometric view of a paddle 100, according to an example of the principles described herein. FIG. 3 illustrates a plan, front view of a paddle 100, according to an example of the principles described herein. FIG. 4 illustrates a plan, side view of a paddle 100, according to an example of the principles described herein. FIG. 5 illustrates a plan, top view of a paddle 100, according to an example of the principles described herein. FIG. 6 illustrates a plan, bottom view of a paddle 100, according to an example of the principles described herein. The paddle 100 of FIGS. 1 through 6 described herein may take any shape and size and may include features not described herein and/or features that are described herein based on a desired form or function of the paddle 100.

The paddle 100 may include a head portion 102 that a user (e.g., player) may use to effectively strike a ball (e.g., a pickleball) during game play. The head portion 102 may include any construction that may be used to strike a ball. In an embodiment, the head portion 102 may have a deflection as defined by a governing body. For example, the head portion 102 may have a deflection of less than 0.0625 inches (in.) under a load of at least 42 pounds (lbs.). This and other types of requirements may result in the head portion 102 having a known or limited spring or “trampoline” effect when utilized during play that does not give an unfair advantage to the user.

The head portion 102 may include, for example, a plurality of layers of materials such as, for example, an exterior layer on each side of the paddle 100 that interacts directly with a ball (e.g., a pickleball) during play. Other layers of materials within the head portion 102 may include any number of intermediary layers between the exterior layer and a core of the paddle 100. Further, the core may be included at the center of the paddle 100. The number of layers of materials within the head portion 102 of the paddle 100 may extend into other portions of the paddle 100, including a throat portion 104 and a handle portion 106.

The paddle 100 may further include a handle portion 106 coupled to the head portion 102. In an embodiment, the handle portion 106 may be monolithically formed with the head portion 102 or may be formed separately and coupled to the head portion 102 via any coupling device and/or means. The handle portion 106 may be used by an individual to handle and manipulate the paddle 100 during play. In an embodiment, the handle portion 106 may include any cross-sectional profile, such as, for example, an octagonal cross-sectional profile to assist the user in keeping the paddle 100 from twisting in their hand. Further, the octagonal cross-sectional profile may assist the user in knowing the orientation of the paddle 100 within their hand; whether that is, for example, a Continental grip, an Eastern forehand grip, a semi-Western grip, a full-Western grip, or other types of grips the user may utilize during play. Knowing the orientation of the paddle 100 with their hand via the octagonal cross-sectional profile allows the user to, on the fly, adjust the position of the paddle 100 within the hand and cause a pickleball to deflect from the surface of the paddle 100 at different angles, at a desired speed, and/or with a desired spin. In an embodiment, the octagonal cross-sectional profile of the handle portion 106 may be achieved through the formation of the handle portion 106 in such a shape. In an embodiment, the octagonal cross-sectional profile of the handle portion 106 may be achieved by application of a number of, or a plurality of, build-up elements that may be coupled to the handle portion 106 via, for example, an adhesive.

The handle portion 106 may further include a butt cap 116 coupled to an end of the handle portion 106. The butt cap 116 may have any shape. In an embodiment, the butt cap 116 may be dimensioned and/or shaped to couple to the end of the octagonal cross-sectional profile of the handle portion 106 through, for example, an engineering fit (e.g., a loose running fit, a free running fit, a close running fit, a sliding fit, or a location fit). Further, in an embodiment, the butt cap 116 may be coupled to the handle portion 106 via an adhesive or other coupling means. In an embodiment, the butt cap 116 may have a relatively wider circumference than the rest of the elements of the handle portion 106 in order to cause the handle portion 106 to feel comfortable within the hand of the user and to keep the paddle 100 from slipping out of the hand of the user when the user swings the paddle 100. The butt cap 116 may include a plastic seal at the base of the butt cap 116 which may include a manufacturer logo, indicia indicating a grip size of the handle portion 106, or other informative indicia.

The handle portion 106 of the paddle 100 may further include one or more layers of grip 118. The grip 118 may include any outer cover applied to the handle portion 106 to create a more padded and comfortable surface for the user to grip onto and to provide a relatively higher coefficient of friction (CoF) to keep the paddle 100 from slipping out of the hand of the user when the user swings the paddle 100. In an embodiment, the paddle 100 may include an “original grip” that serves as the grip 118 and may include a synthetic grip or a genuine leather grip. Further, in an embodiment, the handle portion 106 may include an overgrip to cover and protect the original grip and create an even more cushioned feel and/or an even higher CoF relative to the original grip.

The grip 118 may be secured to the handle portion 106 via grip tape 120. The grip tape 120 may include any tape or other layer used to secure a grip or overgrip in place on the handle portion 106. In an embodiment, a rubber band element referred to as a grip collar may be used in addition to or in place of the grip tape 120.

The paddle 100 may further include a throat portion 104 as described above. The throat portion 104 may include any portions of the head portion 102 and/or the handle portion 106, with the understanding that the region which may be considered a “throat” may vary among different paddles. Thus, the throat portion 104 may include any portion of the paddle 100 between and/or including the head portion 102 and the handle portion 106. In an embodiment, the throat portion 104 of the paddle 100 may include an “open throat” 112. The open throat 112 may include any void through an entirety of the paddle 100 within the throat portion 104 which may provide for a lighter paddle 100 that is relatively more flexible and more powerful. Further, the open throat 112 allows for a decrease in wind resistance as a user swings the paddle 100 since air may flow through the open throat 112 unimpeded, reducing drag that the paddle 100 may create if the open throat 112 were not defined in the paddle 100. In the examples described herein, the paddle 100 may or may not include the open throat 112 defined in the throat portion 104. Further, the open throat 112 may include any shape and dimensions. In examples where the paddle 100 includes an open throat 112, an interior edge guard 114 may be added to the inside portions of the paddle formed by the open throat 112 to enclose any interior layers of the paddle 100 and to create a finished edge to the open throat 112 of the paddle 100.

The paddle 100 may further include an edge guard 110. Even though the paddle 100 is depicted with the edge guard 110, the paddle 100 may or may not include the edge guard 110. In examples where the paddle 100 includes the edge guard 110, the edge guard 110 may include any protective strip applied to the outer edge of the paddle 100 to protect the paddle 100 from impacts, prevent delamination of layers within the paddle 100, and/or enhance the aesthetic appearance of the paddle 100. In an embodiment, the edge guard 110 may be co-molded with the paddle 100. In an embodiment, the edge guard 110 may be coupled to the outer edge of the paddle 100 using adhesives, an engineering fit, mechanical fasteners, welding, other coupling devices or means, and combinations thereof. In an embodiment, the edge guard 110 may include any material that shields the edges of the paddle 100 from damage if and when a user causes the paddle 100 to come into contact with the court or other surface. In an embodiment, the edge guard 110 may be made of metals, metal alloys, plastics, polymers, elastomers, thermoplastic elastomer (TPE), rubbers, natural fibers, natural materials, other materials, and combinations thereof.

The paddle 100 may further include a first face 108-1 and a second face 108-2 positioned at least at the head portion 102 and may extend into the throat portion 104, the handle portion 106, and combinations thereof. The first face 108-1 and the second face 108-2 may be the portion of the paddle 100 that the user may utilize to strike the ball (e.g., a pickleball). Further, the first face 108-1 and the second face 108-2 may include an outer-most layer of the paddle 100, and the internal elements of the paddle 100 may include additional layers of material between the first face 108-1 and the second face 108-2 including a core and/or other layers between the first face 108-1 and the second face 108-2 and the core.

With reference to the axis triad depicted throughout the drawings presented herein, the paddle 100 may have a height as measured along the length of the y-axis. Further, the paddle 100 may have a width as measured along the length of the x-axis. Still further, the paddle 100 may have a thickness (e.g., depth) as measured along the length of the z-axis. Further, a first face 108-1 and a second face 108-2 of paddle 100 lie along the x,y plane and may lie parallel to one another and separated by a distance. Still further, a side (e.g., the location of the edge guard 110) of the paddle 100 that wraps around the paddle 100 at the extents of the first face 108-1 and a second face 108-2 may lie along the z-plane. The length of the side may define the distance at which the first face 108-1 and the second face 108-2 are separated. The first face 108-1, the second face 108-2, and the side of the paddle 100 will be used to describe all the examples of paddles described herein.

The paddle 100 described above is used to describe some aspects of a paddle, such as, for example, a pickleball paddle. However, pickleball paddles may come in varying form factors. As noted above, the present description is directed to a pickleball paddle having a monocoque form factor. In the examples described herein, the monocoque paddles may not include one or more of the elements described above in connection with FIGS. 1 through 6, such as, for example, the edge guard 110 and/or the interior edge guard 114 due to the finished edges of the monocoque paddles. The monocoque paddles may, however, include other elements such as, for example, the butt cap 116, the grip 118, an overgrip, grip tape 120, a grip collar, an open throat 112, or other elements described herein. Further, in an embodiment, the monocoque paddles may include a formed handle portion 106 or buildup elements adhered to the handle portion 106 to provide the octagonal cross-sectional profile of the handle portion 106.

Having described the various features and elements of a paddle 100 with respect to FIGS. 1 through 6, FIG. 7 illustrates an exploded, perspective view of elements utilized in the formation of a monocoque paddle, according to an example of the principles described herein. A manufacturing system used to form the pickleball paddles described herein may include a first mold 702-1, a second mold 702-2, and a bladder 704 that may be used to form a first half shell 706-1 and a second half shell 706-2 of the paddle. As described in more detail below, the first half shell 706-1 and the second half shell 706-2 may be coupled to one another to form the monocoque paddle.

In an embodiment, the first mold 702-1 may be substantially identical to the second mold 702-2 in order to obtain the first half shell 706-1 and the second half shell 706-2 that may be coupled together to form a continuous shell that does not deviate from what may be expected from a monolithically formed paddle or a paddle with no differences between two symmetrical halves. In an embodiment, the two halves of the monocoque paddle including the first half shell 706-1 and the second half shell 706-2 may be formed using the first mold 702-1 and the second mold 702-2 to form a monolithic piece in which the first half shell 706-1 and the second half shell 706-2 are coupled together during the molding process.

The bladder 704 may include any device that may serve as an interior structure against which the interior surfaces of the first half shell 706-1 and the second half shell 706-2 may be formed. In an embodiment, bladder 704 may be made of an inflatable, flexible, elastic, or inelastic material that can be used to define the interior surfaces of the first half shell 706-1 and the second half shell 706-2. In an embodiment, the bladder 704 may be made of a rigid, elastic, or inelastic object that can be used to define the interior surfaces of the first half shell 706-1 and the second half shell 706-2. In an embodiment, instead of or in addition to the bladder 704, pressure may be introduced to the interior of the first half shell 706-1 and the second half shell 706-2 as they are introduced to the first mold 702-1 and the second mold 702-2 to ensure that the materials from which the first half shell 706-1 and the second half shell 706-2 are pressed against the interior portions of the first mold 702-1 and the second mold 702-2.

With the application of the first mold 702-1, the second mold 702-2, and the bladder 704, the first half shell 706-1 and the second half shell 706-2 may be formed such that the walls of the first half shell 706-1 and the second half shell 706-2 may be uniform across the monocoque shells of the first half shell 706-1 and the second half shell 706-2. In other words, the first half shell 706-1 and the second half shell 706-2 may be formed with walls that are of a substantially consistent thickness through the entirety of the first half shell 706-1 and the second half shell 706-2. In an embodiment, the first half shell 706-1 and the second half shell 706-2 may be made of a thermoplastic material that may be formed into the intended shape when subjected to the molding processes described herein and the heat, pressure, and combinations thereof applied to the thermoplastic materials from which the first half shell 706-1 and the second half shell 706-2 are made.

With the monocoque feature of the first half shell 706-1 and the second half shell 706-2, several benefits are realized. For example, from an engineering standpoint, constructing the monocoque pickleball paddle from thermoplastics offers numerous benefits, including a reduction in weight. Thermoplastics are lighter than many traditional materials used in paddle cores and other components. By using a thermoplastic monocoque shell, the paddle May achieve a substantial reduction in weight, enhancing player agility and decreasing fatigue for faster, more sustained gameplay.

Further, constructing the monocoque pickleball paddle from thermoplastics may have the advantage of increased strength and durability. Thermoplastics provide excellent strength-to-weight ratios and impact resistance. The monocoque design of the first half shell 706-1 and the second half shell 706-2 utilizes these properties to distribute stresses and strains evenly across the surfaces of the paddle which, in turn, enhances durability and reduces the likelihood of damage such as cracking or delamination that may be experienced in multi-component paddles.

Still further, constructing the monocoque pickleball paddle from thermoplastics may have the advantage of improved energy transfer. The inherent stiffness of thermoplastic materials in a monocoque construction allows for optimal energy transfer from the paddle to a pickleball, facilitating more powerful and precise volleys and strikes. The rigidity of the paddle also minimizes energy losses that occur through material flexing that may be present in paddles with softer cores and which may result in the paddle being ruled an unapproved paddle based on rules and guidelines of a governing body.

Even still further, constructing the monocoque pickleball paddle from thermoplastics may have the advantage of streamlining manufacturing processes. The use of thermoplastics simplifies the manufacturing process significantly. Unlike other methods that require assembly of multiple layers and components, thermoplastic monocoque paddles may be molded in relatively fewer steps. This not only streamlines production but also improves consistency and quality control across batches.

Further, constructing the monocoque pickleball paddle from thermoplastics may have the advantage of allowing for design versatility. Thermoplastics allow for a high degree of design flexibility, enabling the integration of varied geometries and thicknesses directly into the monocoque shell without compromising structural integrity. This adaptability can be used to fine-tune the balance within the paddle, fine-tune the handling of the paddle, and fine-tune the sweet spot to suit different playing styles and player preferences. Further, this may allow for bespoke paddles to be manufactured at exceptionally low cost and without significantly disrupting the manufacturing process or creating any significant additional time in manufacture.

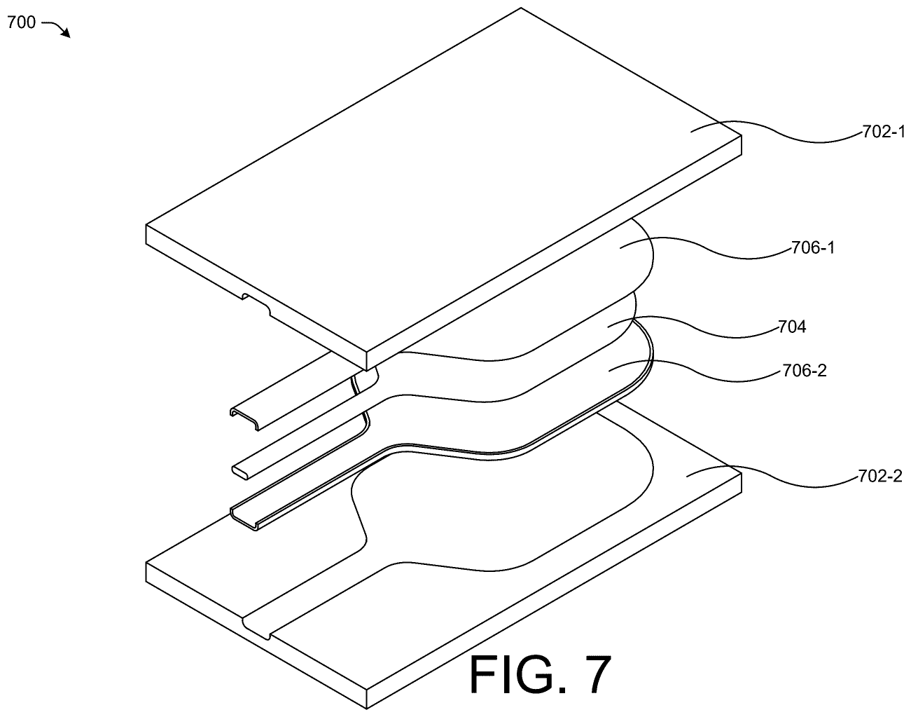

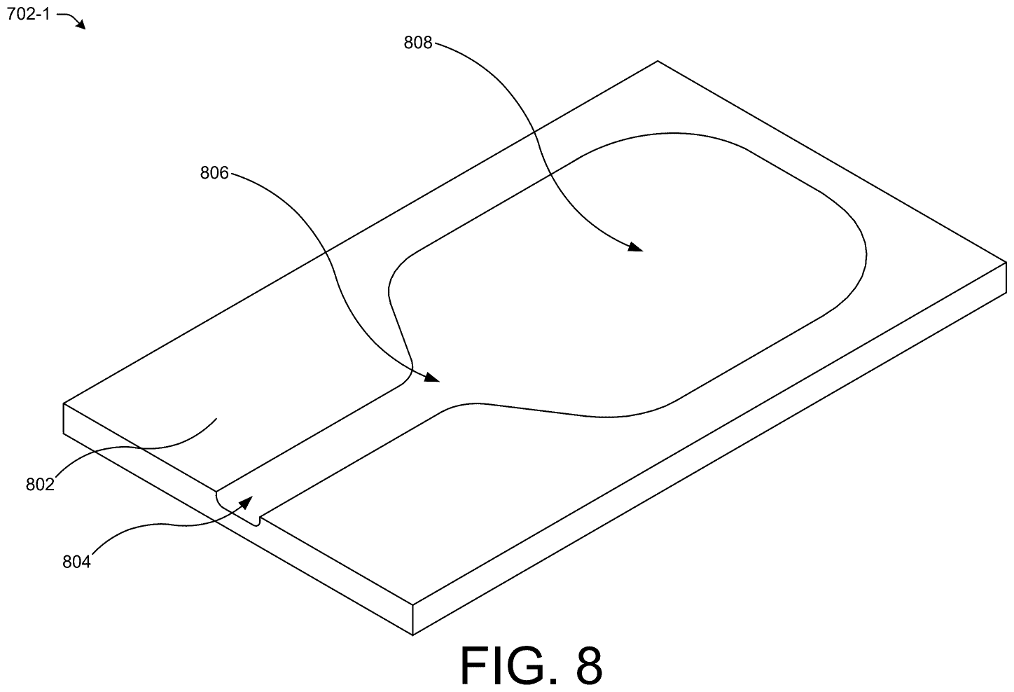

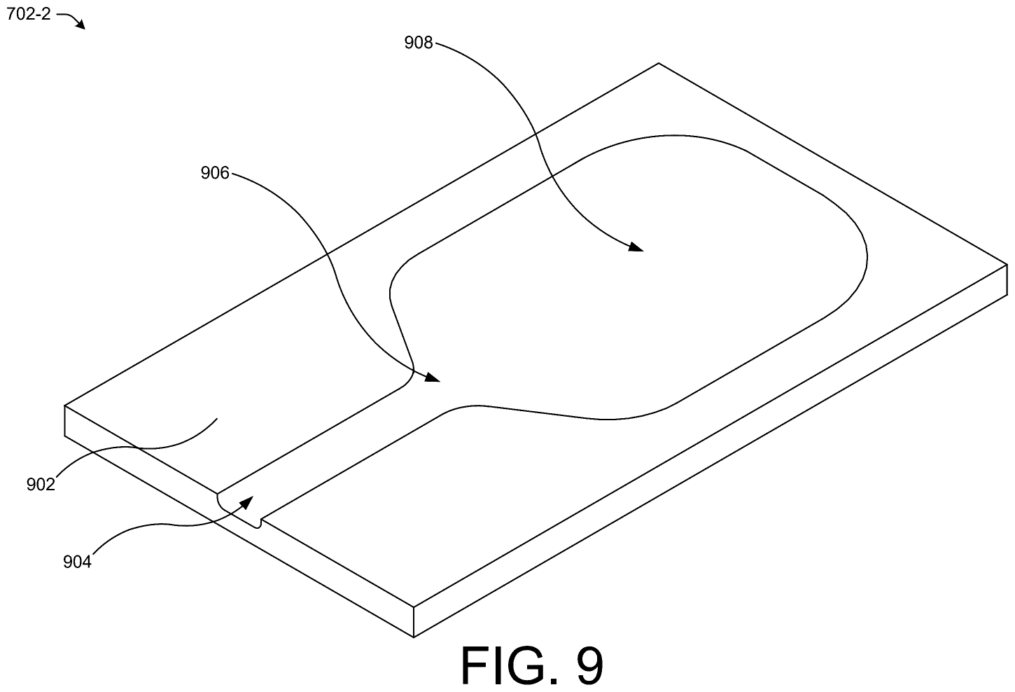

FIG. 8 illustrates a perspective view of the first mold 702-1 depicted in FIG. 7, according to an example of the principles described herein. FIG. 9 illustrates a perspective view of a second mold 702-2 depicted in FIG. 7, according to an example of the principles described herein. In an embodiment, the first mold 702-1 and the second mold 702-2 may be identical or substantially identical so that the first mold 702-1 and the second mold 702-2 create the first half shell 706-1 and the second half shell 706-2 that are identical or substantially identical and a subsequently symmetrical paddle.

The first mold 702-1 and the second mold 702-2 may include a number of, or a plurality of, recesses defined in a base 802, 902. These recesses may include, for example, a handle recess 804, 904 that defines a handle portion of the first half shell 706-1 and the second half shell 706-2, respectively. The recesses may further include a neck recess 806, 906 that defines a neck portion of the first half shell 706-1 and the second half shell 706-2, respectively. Still further, the recesses may include, for example, a face recess 808, 908 that defines a face portion of the first half shell 706-1 and the second half shell 706-2, respectively. In an embodiment, and as depicted in FIGS. 7 through 9, the recesses of the first mold 702-1 and the second mold 702-2, including the handle recess 804, 904, the neck recess 806, 906, and the face recess 808, 908, may constitute a single or continuous recess.

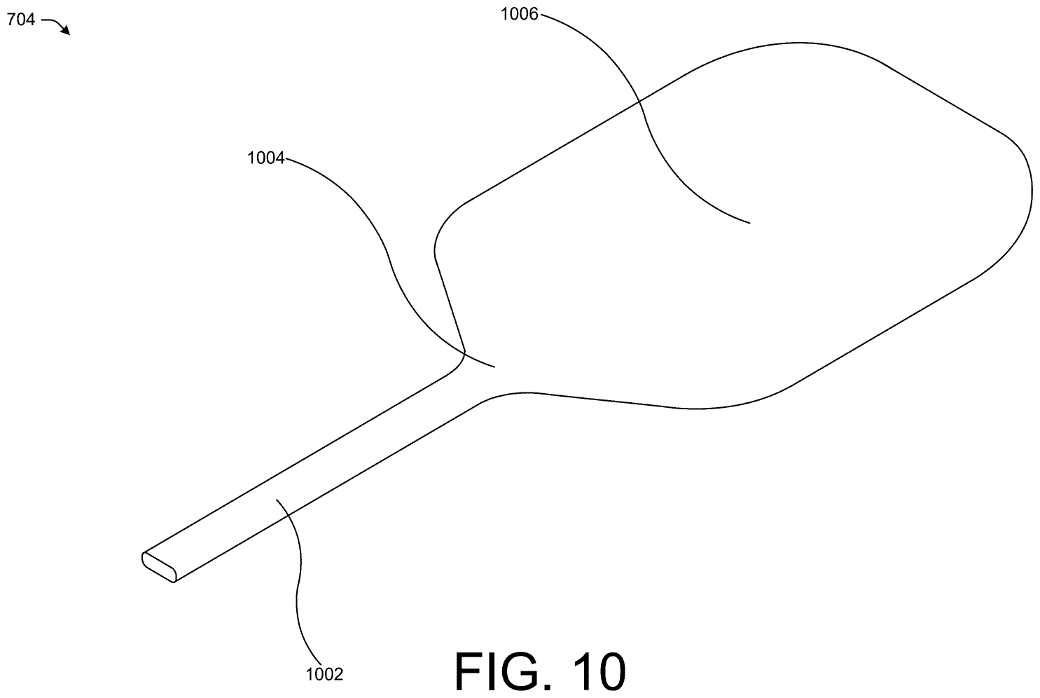

FIG. 10 illustrates a perspective view of the bladder 704 depicted in FIG. 7, according to an example of the principles described herein. The bladder 704 may include a handle portion 1002, a neck portion 1004, and a face portion 1006 that may be used to define an inner surface of the first half shell 706-1 and the second half shell 706-2 that correspond to the handle recess 804, 904, the neck recess 806, 906, and the face recess 808, 908 of the first mold 702-1 and the second mold 702-2. In an embodiment, the bladder 704 may be dimensioned such that the wall created in the first half shell 706-1 and the second half shell 706-2 between the first mold 702-1 and the second mold 702-2 and the bladder 704 may be uniform or substantially uniform.

However, in an embodiment the bladder 704 may be dimensioned such that the wall created in the first half shell 706-1 and the second half shell 706-2 between the first mold 702-1 and the second mold 702-2 and the bladder 704 may be non-uniform to allow for portions of the wall of the first half shell 706-1 and the second half shell 706-2 to be thicker or narrower in defined portions of the first half shell 706-1 and the second half shell 706-2. For example, the bladder 704 may be dimensioned such that the wall created in the first half shell 706-1 and the second half shell 706-2 at, for example, the neck of the paddle is thicker (e.g., due to the dimension of the neck portion 1004 and/or the neck recess 806, 906) to provide strength between the handle and the face of the paddle. Further, in an embodiment, the bladder 704 may be dimensioned such that the wall created in the first half shell 706-1 and the second half shell 706-2 between the first mold 702-1 and the second mold 702-2 and the bladder 704 may create varying thickness along the face of the monocoque paddle (e.g., due to the dimension of the face portion 1006 and/or the face recess 808, 908) to allow for desired sweet-spot location along the face of the paddle among other performance enhancements. Further, in an embodiment, the bladder 704 may be symmetrical such that the interior of the first half shell 706-1 and the second half shell 706-2 are symmetrically identical or substantially symmetrically identical.

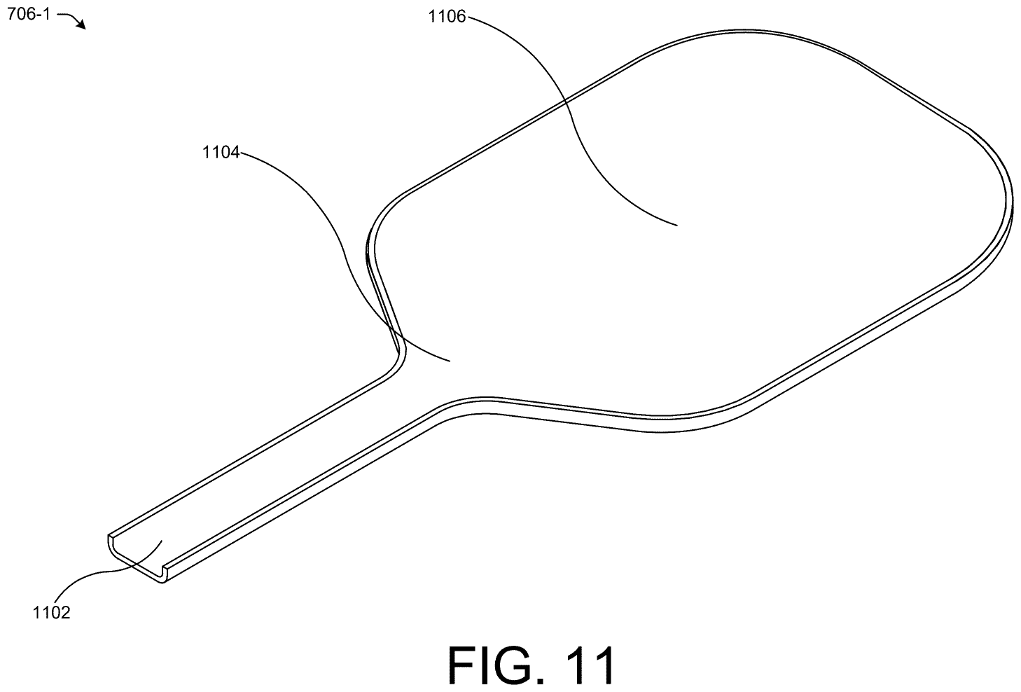

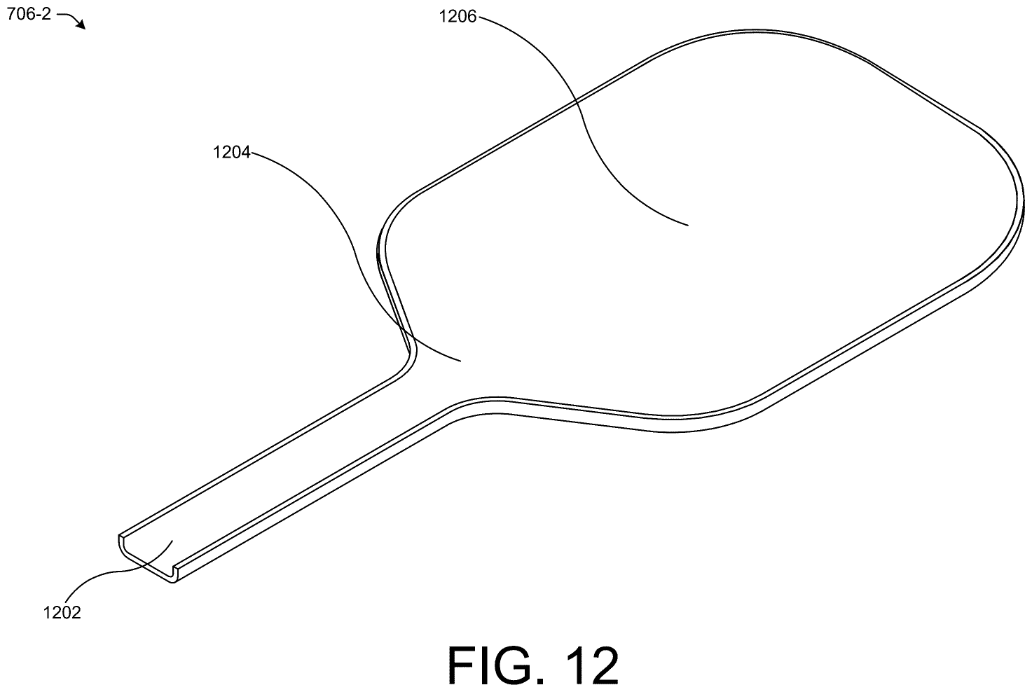

FIG. 11 illustrates a perspective view of a first half shell 706-1 depicted in FIG. 7, according to an example of the principles described herein. FIG. 12 illustrates a perspective view of a second half shell 706-2 depicted in FIG. 7, according to an example of the principles described herein. Since the first half shell 706-1 and the second half shell 706-2 form the paddle as described herein, the first half shell 706-1 and the second half shell 706-2 may each have a handle portion 1102, 1202, a neck portion 1104, 1204, and a face portion 1106, 1206 that serve as a completed paddle when the first half shell 706-1 and the second half shell 706-2 are coupled together.

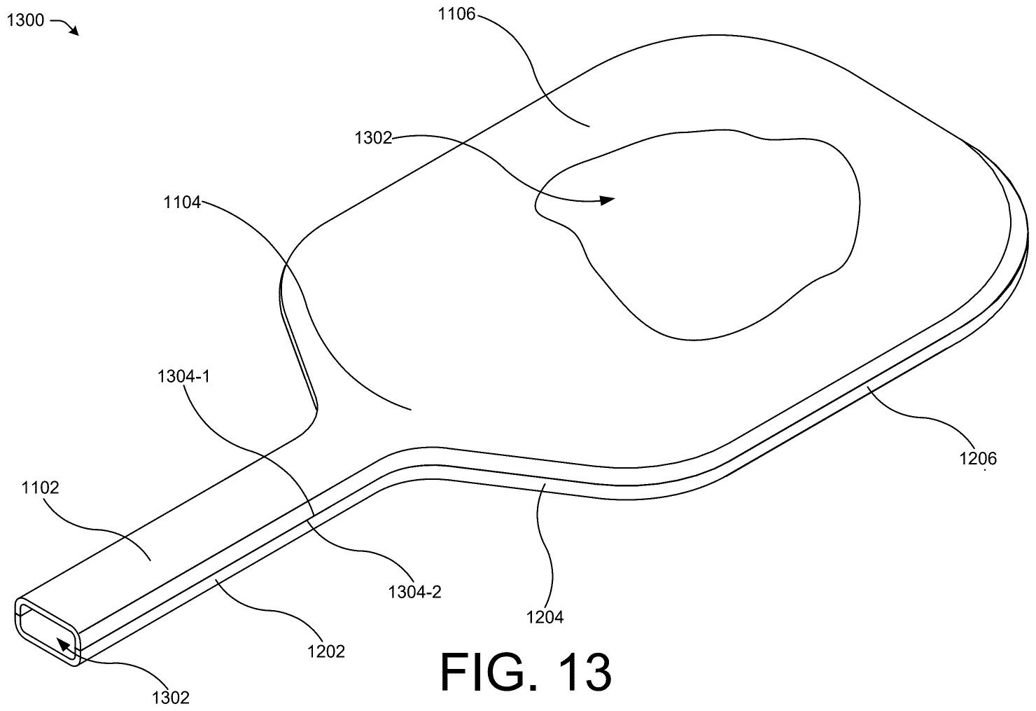

FIG. 13 illustrates a perspective, partially cutaway view of a paddle shell 1300 including the first half shell 706-1 and the second half shell 706-2 depicted in FIGS. 7, 11, and 12 as coupled together, according to an example of the principles described herein. When coupled together, the first half shell 706-1 and the second half shell 706-2 form a monocoque structure.

In order to form this monocoque structure of the paddle, the paddle shell 1300, including the first half shell 706-1 and the second half shell 706-2, may be coupled together by welding edges of the first half shell 706-1 and the second half shell 706-2 together. Welding the first half shell 706-1 and the second half shell 706-2 may include welding between a first extent 1304-1 of the first half shell 706-1 and a second extent 1304-2 of the second half shell 706-2 that abuts the first extent 1304-1 of the first half shell 706-1. The welding of the first half shell 706-1 to the second half shell 706-2 may include ultrasonic welding. Ultrasonic welding may include any industrial process whereby high-frequency ultrasonic acoustic vibrations are locally applied to the first extent 1304-1 of the first half shell 706-1 and the second extent 1304-2 of the second half shell 706-2 that abuts the first extent 1304-1 of the first half shell 706-1. In an embodiment, the ultrasonic welding may be performed when the first half shell 706-1 and the second half shell 706-2 are held together under pressure to create a solid-state weld. Although ultrasonic welding is presented herein as a method of coupling the first half shell 706-1 and the second half shell 706-2, any coupling processes may be utilized including, for example, mechanical joining, cross-linking adhesive bonding, solvent-based adhesive bonding, hotmelt adhesive bonding, vibration welding, heated tool welding, hot gas welding, hot wedge welding, extrusion welding, hot plate welding, implant induction welding, implant resistance welding, spin welding, electromagnetic welding, radio frequency (RF) welding, infrared welding, laser welding, microwave welding, and combinations thereof. Any welding device that may be used to perform this welding may be used.

With the coupling of the first half shell 706-1 to the second half shell 706-2, the paddle shell 1300 is created along with a hollow portion 1302. More details regarding the hollow portion 1302 are provided below. However, the paddle shell 1300, in an embodiment, may be left empty. In this example, the thermoformable material from which the monocoque paddle is constructed may serve as sufficient structure to impart the play characteristics desired.

Further, in an embodiment, a core may be provided in place of the bladder 704, or the bladder 704 may serve as the core of the monocoque paddle. In this example, the bladder 704 or other core material may be retained within the paddle shell 1300 (e.g., including the first half shell 706-1 and the second half shell 706-2), and the welding process described above may be performed as the first half shell 706-1, the second half shell 706-2, and the bladder 704 or other core material are retained in an assembled arrangement.

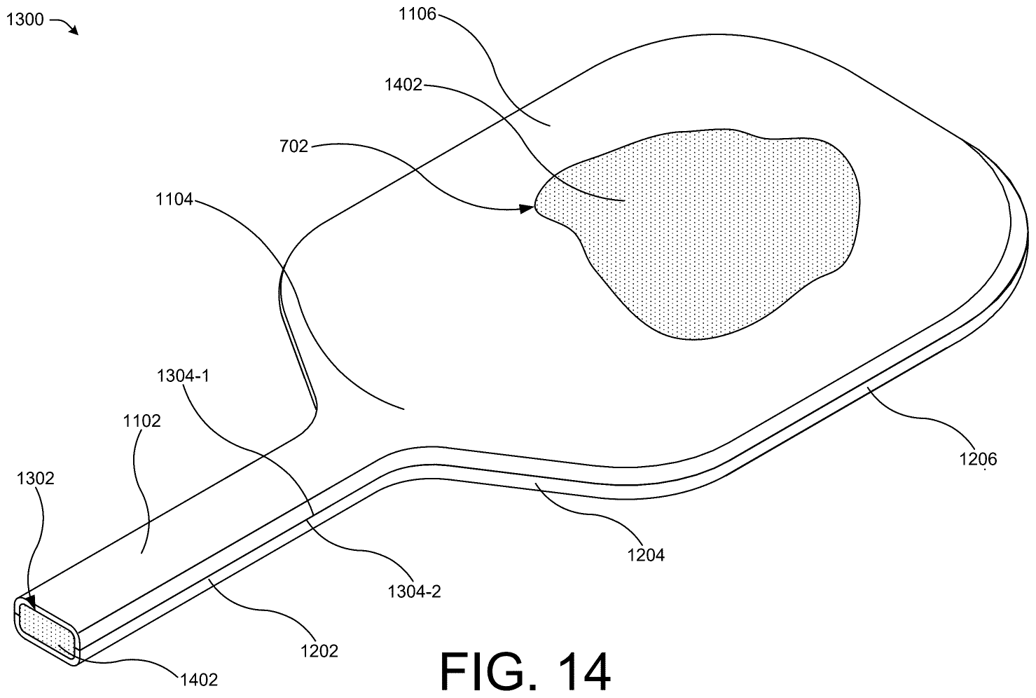

FIG. 14 illustrates a perspective, partially cutaway view of the paddle shell 1300 of FIG. 13 including a material 1402 injected into an internal void defined between the first half shell 706-1 and the second half shell 706-2, according to an example of the principles described herein. The monocoque feature of the paddle described herein allows for the paddle shell 1300 made up of the first half shell 706-1 and the second half shell 706-2 to serve as the structural system in which loads are supported when, for example, the resulting paddle is used to strike a pickleball. However, the material 1402 that may be filled in the hollow portion 1302 of the paddle shell 1300 may include any material that may provide a desired increase in performance of the paddle. For example, the material 1402 may include a polystyrene or expandable foam that provides noise reduction when a pickleball strikes the paddle, a dampening of vibrations when the pickleball strikes the paddle, a larger sweet spot in the face portion 1106, 1108 of the paddle, other desirable performance characteristics, and combinations thereof. In an embodiment, the methods and systems described herein may utilize a second fluid injection device to fill the hollow portion 1302 of the paddle shell 1300 formed between the first half shell 706-1 and the second half shell 706-2 of the paddle shell 1300 with the material.

In addition to the elements of the paddle shell 1300 depicted in FIGS. 13 and 14, a completed paddle may further include texturing on the paddle shell 1300, images printed on the paddle shell 1300, and edge guard 110 and/or an interior edge guard 114, a butt cap 116 affixed to an end of the handle portion 1102, 1202, a formed handle portion 106 or buildup elements adhered to the handle portion 106 to provide the octagonal cross-sectional profile of the handle portion 106 and to create a larger grip for a user, the grip 118, an overgrip, grip tape 120, a grip collar, an open throat 112, pressure-sensitive tape, other finishing elements of a pickleball paddle, and combinations thereof. Further, in an embodiment, a completed monocoque paddle may include embossed features imparted to the paddle via negative features being formed on the interior portions of the first mold 702-1 and the second mold 702-2.

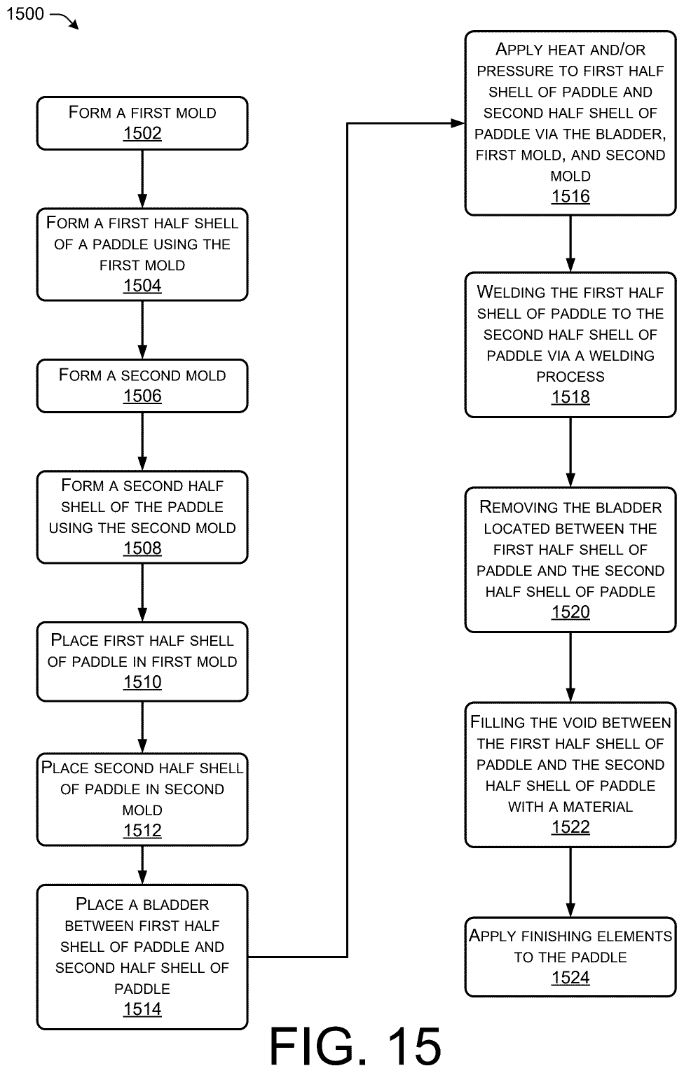

FIG. 15 illustrates a flow diagram of an example method 1500 of forming a paddle, according to an example of the principles described herein. The manufacturing process for creating a monocoque pickleball paddle using a thermoformable material (e.g., thermoplastics) may include a two-step mold press forming technique. At the outset, the first half shell 706-1 and the second half shell 706-2 of the paddle may be molded using the thermoformable materials. The first half shell 706-1 and the second half shell 706-2 may be precisely shaped according to the desired specifications of the final product, including the contour, thickness, and texture of the paddle surfaces.

In a subsequent process, the first half shell 706-1 and the second half shell 706-2 may be brought together in the specialized mold, including the first mold 702-1 and the second mold 702-2 designed to form the complete paddle shape. Inside the first mold 702-1 and the second mold 702-2, the bladder 704 may be placed between the first half shell 706-1 and the second half shell 706-2. The entire assembly including the first mold 702-1, first half shell 706-1, the bladder 704, the second half shell 706-2, and the second mold 702-2 may then be subjected to energy in the form of increased temperatures (e.g., heat) and/or increased pressure. In an embodiment, pressure in the form of pressurized air may be introduced between the first half shell 706-1, the bladder 704, and/or the second half shell 706-2.

As heat and pressure are applied, the bladder 704 may be expanded, pushing the thermoplastic halves (e.g., the first half shell 706-1 and the second half shell 706-2) against the interior surfaces of the first mold 702-1 and the second mold 702-2, respectively. This ensures a tight and seamless bond along the joining edges of the first half shell 706-1 and the second half shell 706-2, while also achieving the exact geometric profile required for optimal performance in the resulting paddle.

The methods of manufacturing the paddle not only ensure a strong, seamless construction but also allow for intricate design features to be integrated into the paddle without compromising structural integrity. The use of thermoformable material and the press forming processes provide high durability, uniform material distribution, and excellent replication of design details, making it a highly efficient and scalable manufacturing process for high-quality pickleball paddles.

Thus, referring to FIG. 15, at 1502, the first mold 702-1 may be formed. The first mold 702-1 may be formed via any mold formation method, such as, for example, subtractive manufacturing methods and/or additive manufacturing processes. The subtractive manufacturing processes may include, for example, milling (e.g., 3-axis, 5-axis computer numerical control (CNC)), turning/lathe machining, drilling, grinding, boring, sawing, tapping/threading, electrical discharge machining (EDM), sinker EDM (e.g., Ram EDM), wire EDM, electrochemical machining (ECM), laser machining/laser ablation, ultrasonic machining, waterjet cutting, plasma cutting, ion beam etching/milling, other subtractive manufacturing processes, and combinations thereof. The additive manufacturing processes may include, for example, polymer-based additive methods, including fused deposition modeling (FDM), stereolithography (SLA), digital light processing (DLP), polyjet/multijet printing, selective laser sintering (SLS), among others, and combinations thereof. The additive manufacturing processes may further include, for example, metal-based additive methods including selective laser melting (SLM), direct metal laser sintering (DMLS), electron beam melting (EBM), binder Jetting (for metal and sand molds), cold spray additive manufacturing, directed energy deposition (DED), among others, and combinations thereof. The additive manufacturing processes may include, for example, sand and investment casting patterns, including binder jetting of sand molds, additive wax pattern printing (e.g., for investment casting), among others, and combinations thereof.

Further, the first mold 702-1 may be formed via any mold formation methods such as, for example, molding, casting, and forming of an element that is used to create the first mold 702-1 such as, for example, via casting into a master mold, epoxy molds, silicone molds, plaster molds, ceramic shell molds (e.g., investment casting), vacuum forming/thermoforming of mold blanks, compression molding to form a negative mold, injection molding to mold a mold (e.g., for high-volume mold inserts), lost wax or lost-PLA techniques where burnout of an additive form casts the mold, other mold formation processes, and combinations thereof. Still further, the first mold 702-1 may be formed via any mold formation methods such as, for example, chemical and thermal methods such as etching/chemical milling, anodic dissolution in ECM, heat sintering of mold materials (e.g., ceramics), infiltration (e.g., metal into printed sand), other methods, and combinations thereof. Even further, the first mold 702-1 may be formed via any hybrid of the formation methods described herein.

At 1504, the first half shell 706-1 may be formed using the first mold 702-1. The second mold 702-2 may similarly be formed at 1506 via the methods described above. In an embodiment, the formation of the second mold 702-2 may be performed such that the second mold 702-2 is identical or substantially identical to the first mold 702-1. The method 1500 may further include, at 1508, forming the second half shell 706-2 using the second mold 702-2.

Once the first half shell 706-1 and the second half shell 706-2 are initially formed, the first half shell 706-1 may be placed in the first mold 702-1 at 1510, and the second half shell 706-2 may be placed in the second mold 702-2 at 1512. Further, at 1514, the bladder 704 may be placed between the first half shell 706-1 and the second half shell 706-2 such that the overall arrangement of these elements is as depicted in FIG. 13.

At 1516 of FIG. 15, the first mold 702-1, the first half shell 706-1, the bladder 704, the second half shell 706-2, and the second mold 702-2 may be brought together to form a “stack” and heat and/or pressure may be applied to the stack. In an embodiment, the heat and/or pressure may cause the first half shell 706-1 and the second half shell 706-2 to be coupled together, but, at 1518, a welding process may be applied to the first half shell 706-1 and the second half shell 706-2 to weld the first half shell 706-1 and the second half shell 706-2 to one another. In an embodiment, the application of heat and/or pressure at 1516 and the application of a welding process at 1518 may be performed simultaneously or directly after one another to create a weld between the first half shell 706-1 and the second half shell 706-2. Further, in an embodiment, the bladder 704 may be expanded during 1516 and/or 1518 to force the interior surfaces of the first half shell 706-1 and the second half shell 706-2 against the interior surfaces of the first mold 702-1 and the second mold 702-2.

In an embodiment, a first fluid injection device may be utilized to create a positive pressure within the bladder 704 during 1516 and/or 1518 to increase the pressure within the bladder 704. The first fluid injection device may inject air, liquid fluids, or other materials to cause the bladder 704 to expand and create pressure against the interior surfaces of the first half shell 706-1 and the second half shell 706-2.

At 1520, the bladder 704 may be removed from between the first half shell 706-1 and the second half shell 706-2, as it may not form part of the final paddle product. In an embodiment, the bladder 704 may be removed by removing air from inside the bladder 704, causing the bladder 704 to collapse to a size small enough to pull out of the hollow portion 1302 through the handle portion 1102, 1202. In an embodiment, the bladder 704 may form part of the final paddle product.

Further, at 1522, in an embodiment, the void between the first half shell 706-1 and the second half shell 706-2 (e.g., hollow portion 1302) may be filled with the material as described above in connection with FIG. 14. In this example, the material may include any material that may expand to fill the hollow portion 1302, such as, for example, polystyrene, expandable foam, or other expandable material.

At 1524, the method 1500 may also include application of a number of finishing elements to the paddle such as application of texturing on the paddle shell 1300, images printed on the paddle shell 1300, and edge guard 110 and/or an interior edge guard 114, a butt cap 116 affixed to an end of the handle portion 1102, 1202, a formed handle portion 106 or buildup elements adhered to the handle portion 106 to provide the octagonal cross-sectional profile of the handle portion 106 and to create a larger grip for a user, the grip 118, an overgrip, grip tape 120, a grip collar, an open throat 112, pressure-sensitive tape, other finishing elements of a pickleball paddle, and combinations thereof.

In an embodiment, the monocoque paddle may include any intermediary layers coupled to or embedded within the first half shell 706-1 and the second half shell 706-2. These intermediary layers may include noise-dampening layers, vibration-dampening layers, fabric layers, woven fabric layers, non-woven fabric layers, fiberglass layers, carbon fiber layers, rheological layers, elastoviscous layers, other types of layers, and combinations thereof.

In an embodiment, the hollow portion 1302 may be filled with any material that fills the space between the first half shell 706-1 and the second half shell 706-2. These materials may include any material that may provide a means by which a coefficient of restitution (CoR) of the monocoque paddle may be tuned in concert with the first half shell 706-1 and the second half shell 706-2 to obtain an acceptable CoR that is within any guidelines defined by a governing body and/or does not give an unfair advantage to the user. As used in the present specification and the appended claims, the terms “coefficient of restitution,” “CoR,” or similar language is meant to be understood broadly as a measure of an elasticity of a collision between two bodies, and may be further defined as a ratio of the relative velocity of separation after a two-body collision to the relative velocity of approach before the collision.

The materials within the hollow portion 1302 between the first half shell 706-1 and the second half shell 706-2 may include any number of materials and combinations of materials. In an embodiment, the materials may include a honeycomb structure. In an embodiment, the honeycomb structure may be made of any material, such as, for example, a thermoplastic, polypropylene (PP), polycarbonate (PC), aluminum, Nomex produced and distributed by DuPont de Nemours, Inc., or other materials. In an embodiment, the honeycomb structure may be made by extrusion that is processed via a block of extruded profiles or extruded tubes having a variety of cell diameters, thicknesses, and densities from which honeycomb sheets may be sliced.

In an embodiment, the materials may include a foam or combinations of foams. In an embodiment, the foam(s) may include an open-cell or closed-cell foam made of a rubber and/or a plastic. More specifically, the foam may include an elastomeric foam including a synthetic rubber such as, for example, nitrile butadiene rubber (NBR), ethylene-propylene-diene monomer (EPDM), or chloroprene rubber (CR), and combinations thereof, combined with a plastic such as, for example, polyvinyl chloride (PVC). The elastomeric foam may include a polyvinyl chloride (PVC), a polyurethane (PU), a thermoplastic elastomer (TPE), an expanded polypropylene (EPP), an expanded polyethylene (EPE), an ethylene vinyl acetate (EVA), and combinations thereof. Further, in an embodiment, the foam may include a chemical foaming agent such as, for example, azodicarbonamide (ADC) to generate gas bubbles during a manufacturing process to create the mechanical structure of the foam. This composition gives the foam flexibility and resilient properties. Specific compositions may be varied depending on desired applications and performance characteristics. Further, the foam may be an ultra-low-density foam, a low-density foam, a high-density foam, and combinations thereof. In an embodiment, the foam may include Bonbon foam (model number B13-B9111) developed and distributed by Tri-Great International, Ltd. In an embodiment, the foam may include any foam with a density of 120 kilograms per cubic meter (kg/m³) or less. The polymer chains in the foam (e.g., an elastomeric foam) may form polymer chains that are cross-linked through a vulcanization process, imparting elastic properties to the elastomeric foam.

### CONCLUSION

The examples described herein provide systems and methods for manufacturing a monocoque paddle and monocoque paddles manufactured via these systems and methods. A monocoque paddle produced by the methods and systems described herein may be relatively inexpensive to manufacture through a streamlined manufacturing process, may provide for versatility in the design of the paddles. Further, the monocoque paddle produced by the methods and systems described herein may exhibit characteristics or qualities that are an improvement over other pickleball paddles including, for example, pickleball paddles that have a reduced weight as compared to other pickleball paddles, pickleball paddles that exhibit an increase in strength and/or durability, pickleball paddles that exhibit improved energy transfer when striking a pickleball, or other improved characteristics or qualities described herein. Therefore, the present monocoque pickleball paddle may provide advantages to a player which may provide the player with an advantage over competitors.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A method of forming a monocoque paddle, the method comprising:
forming a first half shell via a first mold;
forming a second half shell via a second mold;
arranging a bladder between the first half shell and the second half shell;
positioning the first half shell, the bladder, and the second half shell between the first mold and the second mold; and
applying energy to the first half shell and the second half shell via the at least one of the bladder, the first mold, the second mold.

2. The method of claim 1, further comprising welding the first half shell to the second half shell.

3. The method of claim 1, wherein forming the first half shell via the first mold and forming the second half shell via the second mold comprises thermoforming a thermoformable material via the first mold and the second mold.

4. The method of claim 1, further comprising forming an embossed feature on the thermoformable material via a negative feature formed on an interior portion of at least one the first mold, the second mold.

5. The method of claim 1, further comprising:
removing the bladder from between the first half shell and the second half shell; and
filling a void formed between the first half shell and the second half shell with a filling material.

6. The method of claim 5, wherein the filling material comprises a polyol or a polyurethane.

7. The method of claim 1, wherein the applying the energy to the first half shell and the second half shell via the bladder, the first mold, and the second mold causes the first half shell and the second half shell to form a monocoque feature.

8. The method of claim 1, further comprising:
forming the first mold; and
forming the second mold.

9. The method of claim 1, wherein the applying the energy to the first half shell and the second half shell includes at least one of applying heat or applying pressure.

10. A monocoque paddle comprising:
a first half shell formed via a first mold;
a second half shell formed via a second mold; and
a joint formed between the first half shell and the second half shell via application of energy to the first half shell and the second half shell via a bladder, the first mold, and the second mold.

11. The monocoque paddle of claim 10, further comprising a material inserted between the first half shell and the second half shell in place of the bladder.

12. The monocoque paddle of claim 11, wherein the material includes a polyol or a polyurethane.

13. The monocoque paddle of claim 11, wherein the first half shell and the second half shell include a thermoformable material.

14. The monocoque paddle of claim 10, wherein the applying the energy includes applying at least one of heat or pressure.

15. A monocoque paddle manufacturing system comprising:
a first mold for forming a first half shell;
a second mold for forming a second half shell;
a bladder for placement between the first half shell and the second half shell to create a void between the first half shell and the second half shell; and
an energy application device to apply energy to the first half shell and the second half shell via at least one of the bladder, the first mold, the second mold.

16. The monocoque paddle manufacturing system of claim 15, further comprising a welding device to weld the first half shell to the second half shell.

17. The monocoque paddle manufacturing system of claim 16, wherein the welding device includes at least one of a mechanical joining device, a cross-linking adhesive bonding device, a solvent-based adhesive bonding device, a hotmelt adhesive bonding device, an ultrasonic welding device, a vibration welding device, a heated tool welding device, a hot gas welding device, a hot wedge welding device, an extrusion welding device, a hot plate welding device, an implant induction welding device, an implant resistance welding device, a spin welding device, an electromagnetic welding device, a radio frequency (RF) welding device, an infrared welding device, a laser welding device, or a microwave welding device.

18. The monocoque paddle manufacturing system of claim 15, further comprising a first fluid injection device to create a positive pressure within the bladder.

19. The monocoque paddle manufacturing system of claim 18, further comprising a second fluid injection device to fill a void formed between the first half shell and the second half shell with a filling material.

20. The monocoque paddle manufacturing system of claim 19, wherein the filling material comprises a polyol or a polyurethane.
